(19) United States
(12) Patent Application Publication
(10) Pub. No.: US 2017/0148123 A1
(43) Pub. Date: May 25, 2017

(54) METHOD AND SYSTEM FOR GENERATING A PHYSICIAN RECOMMENDATION

(71) Applicant: XpertDox, LLC, Birmingham, AL (US)

(72) Inventor: Sameer Ather, Birmingham, AL (US)

(21) Appl. No.: 15/353,810

(22) Filed: Nov. 17, 2016

Related U.S. Application Data
(60) Provisional application No. 62/257,737, filed on Nov. 20, 2015.

(51) Int. Cl. G06Q 50/22; G06F 17/30; G06Q 30/02

(52) U.S. Cl. CPC G06Q 50/22; G06Q 30/02; G06F 17/30554; G06F 17/30864; G06F 17/3053

(57) ABSTRACT

The present invention provides a system and method for generating a physician recommendation. The method for generating said physician recommendation to said user comprising receiving an input search criterion by a physician recommendation platform using one or more communication devices; identifying one or more physician according to said received input search criterion based on a plurality of attributes; comparing one or more identified physicians based on a scoring mechanism; and displaying a list of physician to said user corresponding to said received input search criterion.

### CROSS-REFERENCE TO RELATED APPLICATION

The present application is related to provisional patent application Ser. No. 62257737, filed on Nov. 20, 2015, and titled “PHYSICIAN RECOMMENDATION SYSTEM”. The entire disclosure of the above patent application is hereby incorporated by reference.

### FIELD OF INVENTION

The present application generally relates to healthcare services and in particular, it relates to recommendation of a list of physicians based on an input search criterion.

### BACKGROUND

There are no objective measures by which one can identify a doctor's expertise in a particular disease, procedure or medicine. Some doctors display their expertise on their own website but there is no third party validation for the same. Thus, patients depend on their primary care physician to guide them to the specialist doctor for their disease. Further, the current system does not allow for comparison of two or more doctors for a particular search criterion which could be a disease, medicine or procedure.

In conventional systems, the physician recommendation is based on different factors such as patients' review of doctors, doctors' nomination by a panel of experts, and number of patients seen by a doctor. However, these factors limit the scope of physician recommendation system for searching and recommending physicians based on the input search criteria.

Thus, in light of the above mentioned background art, it is evident that, there is a need for a method and system for generating a physician recommendation that overcomes the above stated problems.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a method and system for generating a physician recommendation.

In embodiments, the present invention provides a method for generating a physician recommendation. The method includes receiving input search criterion, identifying one or more physicians, comparing one or more physicians, and displaying a list of physician corresponding to the input search criterion.

In an embodiment, the input search criterion is based on diseases, procedure and medicines.

In an embodiment, identifying one or more physicians is based on various attributes in different domains. List of the domains includes, but are not limited to Clinical expertise in the search criterion, research contributions related to search criterion, and Subject authority. The subject authority is based on education contributions, leadership roles held among peers and number of referrals.

In an embodiment, the method further enables auto completion of the input search criterion.

In an embodiment, comparing one or more physicians is based on a scoring mechanism.

In an embodiment, displaying physician recommendations in various forms.

In another aspect, the present invention provides a system for generating a physician recommendation. The system includes an information storage module, an input detection module, one or more processing modules, and an analytics module. The information storage module is configured to store information related to one or more physicians and information related to a user. The input detection module is configured to detect and interpret an input search criterion. The one or more processing modules are configured to process the input search criterion and identify one or more physician correspondence to the search criterion. The analytics module is configured to compare one or more physicians based on a scoring mechanism and provide a list of physician correspondence to the search criterion. The system displays the list of physician correspondence to the search criterion.

In an embodiment, the system suggests auto completion of the input search criterion.

In an embodiment, the system is multifaceted. The physician recommendations is not based on a single attribute, rather, it is based on various attributes in different domains. List of attributes includes, but is not limited to number of publications as first or last author for each search term, number of publications not as first or last author for each search term, number of citations for publications in which the doctor is first or last author for each search term, number of citations for publications in which the doctor is not a first or last author for each search term, ratio of original article and total publications, ratio of human studies and total publication, number of patients a doctor sees with a particular disease, number of a particular medicine prescribed by a doctor, number of a particular procedure performed by a doctor, invited chapters in a book on a particular topic, leadership positions in a national organization, number of referrals from peers, and honor in local and regional chapters.

In an embodiment, the system is unbiased. The system does not require input from either patients or doctors and thus avoids a bias.

In an embodiment, the system provides personalized physician recommendations. Identification of physician is based on disease, medicine or procedure.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1 illustrates a system for generating a physician recommendation, in accordance with various embodiments of the present invention;

FIG. 2 illustrates a flowchart for generating a physician recommendation, in accordance with various embodiments of the present invention.

FIG. 3a illustrates a user interface for receiving an input search criterion, in accordance with various embodiments of the present invention.

FIG. 3b illustrates a user interface for providing search term suggestions, in accordance with various embodiments of the present invention.

FIG. 3c illustrates a user interface for selecting a category, in accordance with various embodiments of the present invention.

FIG. 3d illustrates a user interface for displaying a list of physician recommendation, in accordance with various embodiments of the present invention.

FIG. 3e illustrates a user interface for filtering the list of physician recommendation, in accordance with various embodiments of the present invention.

FIG. 4 illustrates a block diagram of a physician recommendation platform, in accordance with various embodiments of the present invention.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

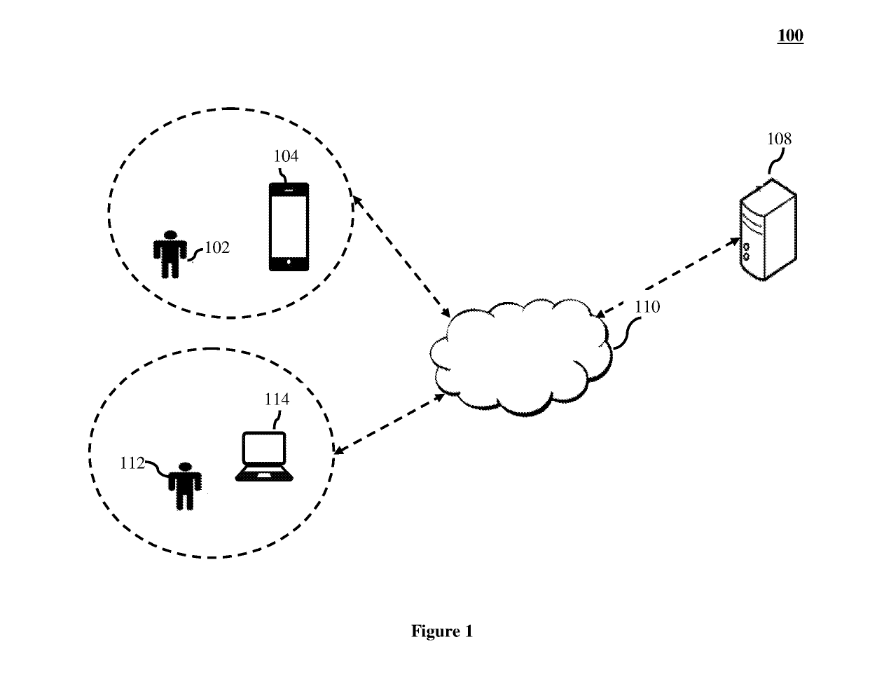

Referring to FIG. 1 is a system for generating a physician recommendation, in accordance with various embodiments of the present invention. The system 100 includes a communication device 104 associated with a user 102, a communication device 114 associated with a user 112, and a physician recommendation platform 108. The communication device 104 and the communication device 114 communicate with the physician recommendation platform 108 through a communication network 110. The functions and capabilities of the communication device 104 are same as the functions and capabilities of the communication device 114. Examples of the user 102 include, but are not limited to a user, a patient, healthcare personnel, an administrator, a caretaker, an assistant, and any authority.

In context of the present invention, the communication device 104 refers to a handheld electronic device that can be used to communicate over the communication network 110. Examples of the communication device 104 include, but are not limited to a cell phone, a smart phone, a cellular phone, a cellular mobile phone, a personal digital assistant (PDA), a navigation terminal, a personal computer, a laptop, and a tablet computer. Examples of types of the communication network include, but are not limited to a local area network, a wide area network, a radio network, a virtual private network, an internet area network, a metropolitan area network, a satellite network, Wi-Fi, Bluetooth Low energy, a wireless network, and a telecommunication network. Examples of the telecommunication network include, but are not be limited to a global system for mobile communication (GSM) network, a general packet radio service (GPRS) network, third Generation Partnership Project (3GPP), 4G, Long-Term Evolution (LTE), an enhanced data GSM environment (EDGE) and a Universal Mobile Telecommunications System (UMTS).

The physician recommendation platform 108 refers to a platform that provides a list of physician recommendation to the user 102 for an input search criterion. The user 102 inputs the search criterion through the communication device 104. The physician recommendation platform 108 receives the input search criterion from the communication device 104. In an embodiment, the physician recommendation platform 108 stores information related to one or more physicians. The physician recommendation platform 108 processes the input search criterion and identifies one or more physician correspondence to the search criterion. In an embodiment, the physician recommendation platform 108 identifies one or more physician based on a comparison among one or more physicians. In an embodiment, the comparison among one or more physicians is based on a scoring mechanism. In an embodiment, the physician recommendation platform 108 displays a list of physician recommendation obtained from the scoring mechanism. In an embodiment, the physician having more score is displayed on the top. In an embodiment, the physician having more score is displayed on the bottom with a visual cue.

In an embodiment, the physician recommendations is not based on a single attribute, rather, it is based on various attributes in different domains. Examples of the domains include, but are not limited to Clinical expertise for a search term, Research contributions related to search term, and Subject authority. The subject authority is based on education contributions, leadership roles held among peers and number of referrals. Examples of attributes include, but is not limited to number of publications as first or last author for each search term, number of publications not as first or last author for each search term, number of citations for publications in which the doctor is first or last author for each search term, number of citations for publications in which the doctor is not a first or last author for each search term, ratio of original article and total publications, ratio of human studies and total publication, number of patients a doctor sees with a particular disease, number of a particular medicine prescribed by a doctor, number of a particular procedure performed by a doctor, invited chapters in a book on a particular topic, leadership positions in a national organization, number of referrals from peers, and honor in local and regional chapters.

In an embodiment, the scoring mechanism includes assigning various weights to each attributes. In another embodiment, the scoring mechanism includes analyzing strengths of association of each attribute with the input search criterion. Further, for a given search criterion, a score for a physician will be calculated based on at least one of the various weights to each attributes and strengths of association of each attributes with the input search criterion. For a particular search criterion, the physician associated with highest score will be displayed on the top. In an embodiment, displaying a list of physician recommendations based on the descending order of the score. In an embodiment, displaying a list of physician recommendations based on the ascending order of the score.

In an embodiment, the physician recommendation is unbiased. The physician recommendation platform 108 does not require input from either patients or doctors and thus avoids a bias. In an embodiment, the physician recommendation platform 108 provides personalized physician recommendations.

Furthermore, the physician recommendation platform 108 displays a list of physician recommendations in various forms. Example of various forms includes, but is not limited to a graphical chart, a tabular form, voice guidance, a multimedia element, an animated report, and an interactive web element.

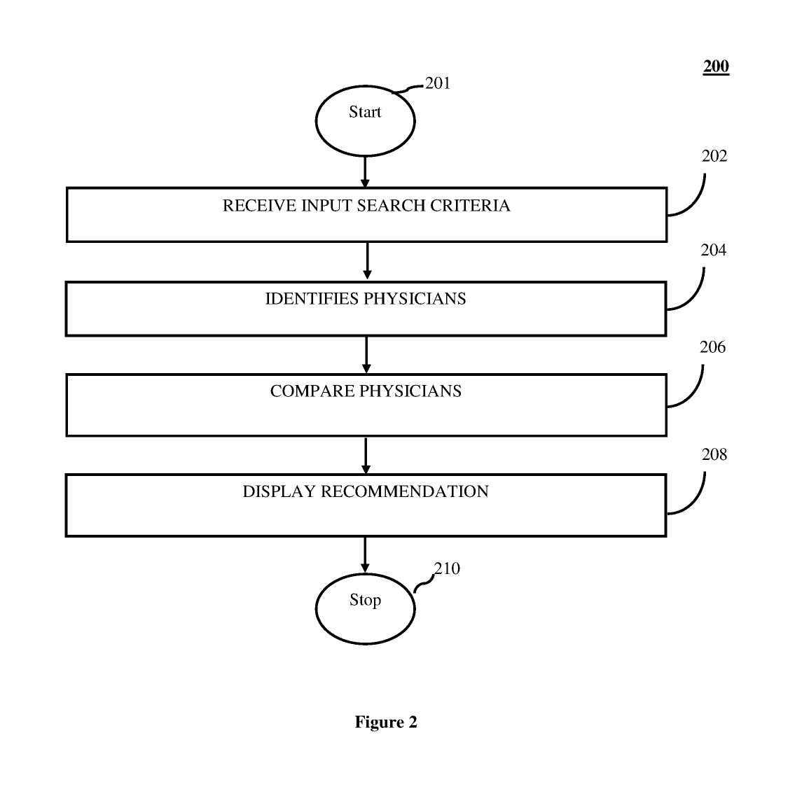

FIG. 2 illustrates a flowchart 200 for generating a list of physician recommendations, in accordance with various embodiments of the present invention. At step 201, the flowchart 200 initiates. At step 202, the physician recommendation platform 108 receives the input search criterion from the communication device 104. In an embodiment, the physician recommendation platform 108 receives the input search criterion from a registered communication device. In another embodiment, the physician recommendation platform 108 receives the input search criterion from a registered user. In an embodiment, the physician recommendation platform 108 stores various information related to one or more physicians.

At step 204, the physician recommendation platform 108 processes the input search criterion and identifies one or more physician correspondence to the search criterion. At step 206, the physician recommendation platform 108 compares the one or more physicians based on a scoring mechanism.

At step 208, the physician recommendation platform 108 displays a list of physician recommendations obtained from the scoring mechanism. In an embodiment, displaying a list of physician recommendations based on the descending order of the score. In an embodiment, displaying a list of physician recommendations based on the ascending order of the score. At step 210, the flowchart 200 terminates.

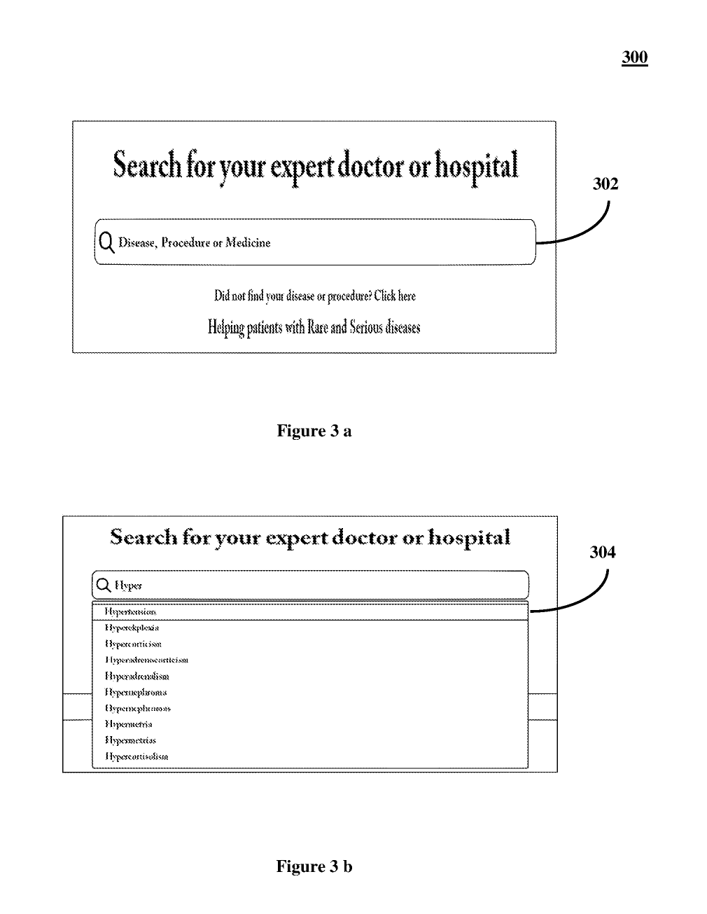

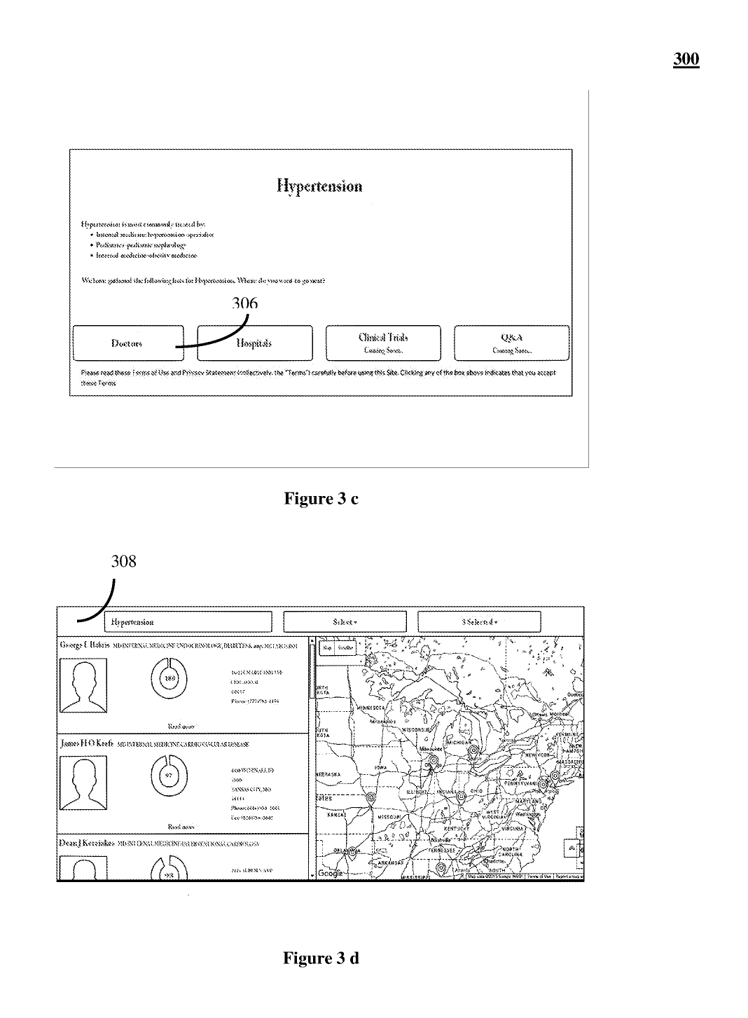

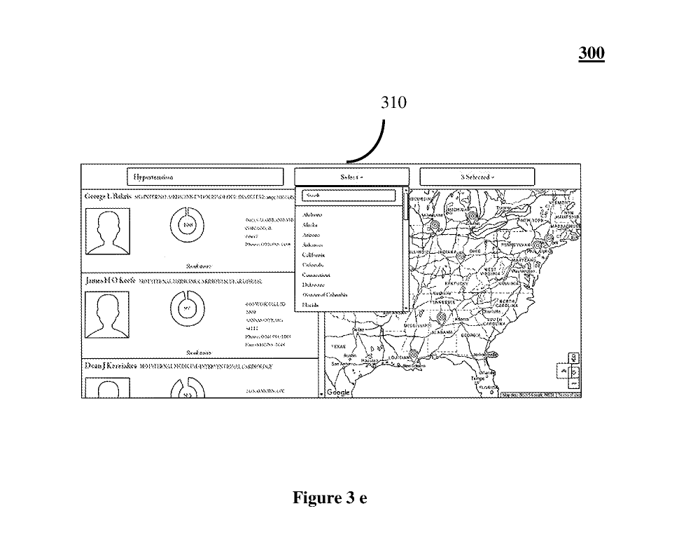

FIG. 3a illustrates a user interface 302 for receiving an input search criterion, in accordance with various embodiments of the present invention. In an embodiment, the user interface 302 is a search box. Search boxes are accompanied by a search button. In another embodiment, the user interface 302 is an input text box. In yet another embodiment, the user interface 302 is a search field. In an embodiment, the user interface 302 includes guided text. In context of the present invention, the guided text is disease, procedure or medicine.

FIG. 3b illustrates a user interface 304 for providing search term suggestions, in accordance with various embodiments of the present invention. In an embodiment, the user interface 304 displayed the search term suggestions using ontology. In an embodiment, the user interface 304 displayed the search term suggestions based on grammar and dictionary. In some examples, the user interface 304 may receive one or more indications of input to select one or more keys of a keyboard. Responsive to receiving the indications, the user interface 304 may utilize a language model to determine one or more word suggestions. For instance, the user interface 304 may determine a probability that a string of characters corresponding to one or more selected keys is included in or is a misspelling of at least one of the word suggestions. The user interface 304 may rank each word suggestion based on a probability that the word suggestion is the word actually intended by the user. For example, if the user interface 304 may receive a series of one or more character “hyper”, it displays one or more search term suggestions such as hypertension, hyperekplexia, hypercorticism, and the like.

FIG. 3c illustrates a user interface 306 for selecting a category, in accordance with various embodiments of the present invention. The user 102 may select one of the displayed categories. In an embodiment, the user interface 306 may be a web element. In another embodiment, the user interface 306 may include a radio button. In yet another embodiment, the user interface 306 may include a check box. In yet another embodiment, the user interface 306 may include an interactive web element.

FIG. 3d illustrates a user interface 308 for displaying a list of physician recommendation, in accordance with various embodiments of the present invention. In an embodiment, the user interface 308 displays computed score of each physician. In another embodiment, the user interface 308 displays physical address of each physician. In an embodiment, the physical address of a physician is displayed on an electronic map. In yet another embodiment, the user interface 308 displays a web button correspondence to more details about the physician. When the user 102 click the web button correspondence to more details about the physician, more information about the physician will be displayed. In yet another embodiment, the user interface 308 displays the department of each physician. In yet another embodiment, the user interface 308 displays the designation of each physician.

FIG. 3e illustrates a user interface 310 for filtering the list of physician recommendations displayed on the user interface 310, in accordance with various embodiments of the present invention. In an embodiment, the user interface 310 includes a list of locations. Example of location may includes, but is not limited to a state name, a country name, a city name, a metro city name, an area name, and a street name. The user 102 may choose one of the locations to filter out the list of physician recommendations displayed on the user interface 310.

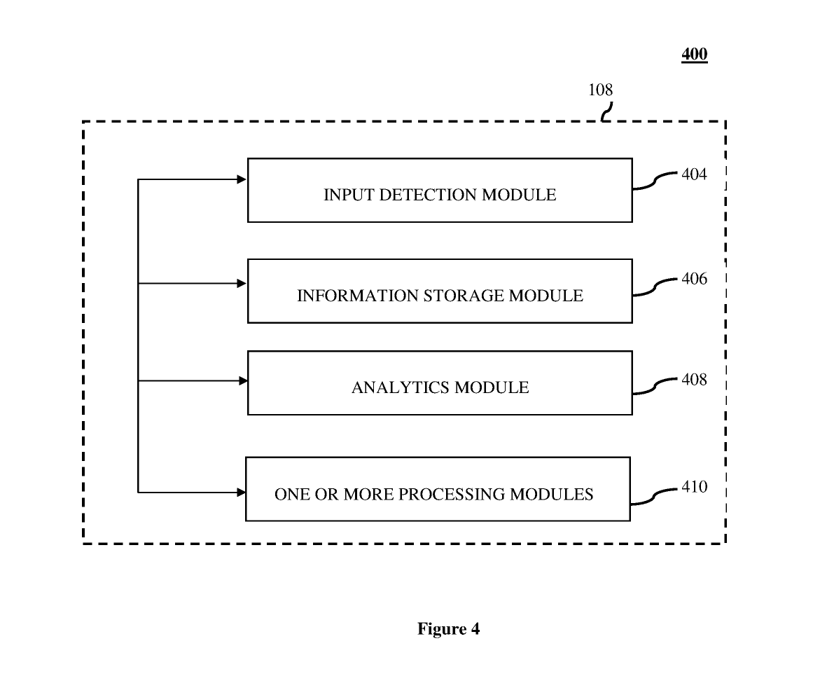

FIG. 4 illustrates a block diagram 400 of the physician recommendation platform 108, in accordance with various embodiments of the present invention. The block diagram 400 of the physician recommendation platform 108 includes an information storage module 406, an input detection module 404, one or more processing modules 410 and an analytics module 408.

The input detection module 404 of the physician recommendation platform 108 detects the input search criterion. In an embodiment, the user 102 inputs the search criterion through the communication device 104. In an embodiment, the user 102 inputs the search criterion directly on a graphical user interface of the physician recommendation platform 108. In an embodiment, the detection module 404 may include a user interface for receiving input search criterion. In an embodiment, the user interface is a search box. Search boxes are accompanied by a search button. In another embodiment, the user interface is an input text box. In yet another embodiment, the user interface is a search field.

Further, one or more processing modules 410 of the physician recommendation platform 108 process the input search criterion and identify one or more physician correspondence to the search criterion. In an embodiment, the one or more processing module 410 is associated with a memory module. The memory module accessible by the one or more processing module 410 receives and stores data. The memory module may be a main memory, such as a high speed Random Access Memory (RAM), or an auxiliary storage unit, such as a hard disk, a floppy disk, or a magnetic tape drive. The memory may be any other type of memory, such as a Read-Only Memory (ROM), or optical storage media such as a videodisc and a compact disc. The one or more processing module 350 may access the memory module to retrieve data. Examples of one or more processing module includes, but are not limited to a central processing unit (CPU), a front-end processor, a microprocessor, a graphics processing unit (GPUNPU), a physics processing unit (PPU), a digital signal processor, and a network processor.

Furthermore, the analytics module 408 of the physician recommendation platform 108 compares one or more physicians based on a scoring mechanism and provides a list of physician correspondence to the search criterion. In an embodiment, the physician having more score is displayed on the top. In an embodiment, the physician having more score is displayed on the bottom with a visual cue. In an embodiment, providing a list of physician correspondence to the search criterion is not based on a single attribute, rather, it is based on various attributes in different domains. Examples of the domains include, but are not limited to Clinical expertise for a search term, Research contributions related to search term, and Subject authority. The subject authority is based on education contributions, leadership roles held among peers and number of referrals. Examples of attributes include, but is not limited to number of publications as first or last author for each search term, number of publications not as first or last author for each search term, number of citations for publications in which the doctor is first or last author for each search term, number of citations for publications in which the doctor is not a first or last author for each search term, ratio of original article and total publications, ratio of human studies and total publication, number of patients a doctor sees with a particular disease, number of a particular medicine prescribed by a doctor, number of a particular procedure performed by a doctor, invited chapters in a book on a particular topic, leadership positions in a national organization, number of referrals from peers, and honor in local and regional chapters. In an embodiment, the scoring mechanism includes assigning various weights to each attributes. In another embodiment, the scoring mechanism includes analyzing strengths of association of each attributes with the input search criterion. Further, for a given search criterion, a score for a physician will be calculated based on at least one of the various weights to each attributes and strengths of association of each attributes with the input search criterion. For a particular search criterion, the physician associated with highest score will be displayed on the top. In an embodiment, displaying a list of physician recommendations based on the descending order of the score. In an embodiment, displaying a list of physician recommendations based on the ascending order of the score. In an embodiment, the physician recommendation is unbiased. The physician recommendation platform 108 does not require input from either patients or doctors and thus avoids a bias. In an embodiment, the physician recommendation platform 108 provides personalized physician recommendations.

Furthermore, the physician recommendation platform 108 displays a list of physician recommendation in various forms. Example of various forms includes, but is not limited to a graphical chart, a tabular form, voice guidance, a multimedia element, an animated report, and an interactive web element.

Furthermore, the information storage module 406 of the physician recommendation platform 108 stores information related to one or more physicians and information related to a user. In an embodiment, the information storage module 406 is a multi-tier storage system. In another embodiment, the information storage module 406 stores the information in an encrypted format. In yet another embodiment, the information storage module 406 stores the information in an indexed format. The storage module 406 facilitates storage, retrieval, modification, and deletion of data in conjunction with various data-processing operations. Storage module information may be retrieved through queries using keywords and sorting commands, in order to rapidly search, rearrange, group, and select the field.

In one embodiment, the storage module 406 is secure web servers and Hypertext Transport Protocol Secure (HTTPS) capable of supporting Transport Layer Security (TLS. Communications to and from the secure web servers may be secured using Secure Sockets Layer (SSL). An SSL session may be started by sending a request to the Web server with an HTTPS prefix in the URL. Alternatively, any known communication protocols that enable devices within a computer network to exchange information may be used. Examples of protocols are as follows: IP (Internet Protocol), UDP (User Datagram Protocol), TCP (Transmission Control Protocol), DHCP (Dynamic Host Configuration Protocol), HTTP (Hypertext Transfer Protocol), FTP (File Transfer Protocol), Telnet (Telnet Remote Protocol), SSH (Secure Shell Remote Protocol), POP3 (Post Office Protocol 3), SMTP (Simple Mail Transfer Protocol), IMAP (Internet Message Access Protocol), SOAP (Simple Object Access Protocol), PPP (Point-to-Point Protocol), RFB (Remote Frame buffer) Protocol.

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Users skilled in the art and technology to which this application pertains will appreciate that alterations and changes in the described structures and methods of operation can be practiced without meaningfully departing from the principle, spirit and scope.

I claim:

1. A method for generating a physician recommendation to a user (102), said method for generating said physician recommendation to said user (102) comprising:
a. receiving an input search criterion by a physician recommendation platform (108) using one or more communication devices (104; 114);
b. identifying one or more physician according to said received input search criterion based on a plurality of attributes;
c. comparing one or more identified physicians based on a scoring mechanism; and
d. displaying a list of physician to said user (102) corresponding to said received input search criterion.

2. The method as claimed in claim 1, wherein said input search criterion is based on at least one disease, procedure and medicine.

3. The method as claimed in claim 1, wherein said plurality of attributes for identification of one or more physician is selected from a group comprising of clinical expertise, research contribution, education contribution, subject authority, authorship, number of academic publications as first, subsequent or last author, number of citations for said publications, invited chapters in a book on a particular topic, ratio of original article and total publications, ratio of human studies and total publication, number of patients said one or more physician with a particular disease, number of a particular medicine prescribed by said one or more physician, number of a particular procedure performed by said one or more physician, and leadership role in a national organization, number of referrals from peers, and honor in local and regional chapters of said one or more physician pertaining to said input search criterion.

4. The method as claimed in claim 1, further comprise of enabling auto completion of said input search criterion.

5. The method as claimed in claim 1, wherein said scoring mechanism comprises of assigning a weightage to said plurality of attributes; analyzing strength of association of said plurality of attributes with said input search criterion; calculating a score based on said assigned weightage to said plurality of attributes and strength of association of said plurality of attributes with said input search criterion for a given input search criterion.

6. The method as claimed in claim 1, wherein said list of physicians is displayed in a descending or an ascending order of based on said scoring mechanism.

7. The method as claimed in claim 1, wherein said list of physician is displayed to said user (102) corresponding to said received input search criterion in form of a graphical chart, a tabular form, voice guidance, a multimedia element, an animated report, or an interactive web element.

8. A system (100) for generating a physician recommendation to a user (102) using a physician recommendation platform (108) communicatively coupled with one or more communication devices (104; 114) through a communication network (110), said system for (100) generating said physician recommendation to said user (102) comprising:
a. an input detection module (404), configured to receive, detect and interpret an input search criterion by said physician recommendation platform (108) using one or more communication devices (104; 114);
b. an information storage module (406), configured to store information related to one or more physician and information related to said user (102);
c. an analytics module (408), configured to compare one or more identified physicians based on a scoring mechanism and provide a list of physician correspondence to said input search criterion; and
d. one or more processing modules (410), configured to process said input search criterion and identify one or more physician corresponding to said input search criterion based on a plurality of attributes.
